(19) United States
(12) Patent Application Publication
(10) Pub. No.: US 2024/0416182 A1
(43) Pub. Date: Dec. 19, 2024

(54) EXERCISE DEVICE COMMUNICATION SYSTEM

(71) Applicant: Zwift, Inc., Long Beach, CA (US)

(72) Inventors: Alexandru Andreescu, London (GB); Davide Pollarolo, London (GB)

(21) Appl. No.: 18/334,110

(22) Filed: Jun. 13, 2023

(51) Int. Cl. A63B 24/00

(52) U.S. Cl. CPC A63B 24/0087; A63B 2071/0638; A63B 2225/20

(57) ABSTRACT

There is disclosed a system for control of a resistance device. The system includes a resistance device in communication with a computing device executing software to simulate a virtual environment in which exercise may take place with resistance for the exercise provided by the resistance device as directed by the software. The computing device used in the system includes a processor and memory, the processor executing the software to generate the virtual environment in which a user may engage in the exercise. The system further includes a remote control, the remote control in communication with the computing device for providing resistance setting signals to the computing device. The system relies upon resistance setting signals being translated by the computing device into a resistance control signals by the computing device which is then transmitted to the resistance device to alter the resistance applied by the resistance device.

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to communications protocols and, more particularly to a protocol for communicating with software used to engage in exercise in conjunction with one or more accessory devices.

### Description of the Related Art

Over the last several, years, the gamification of exercise and the integration of social networks or network effects more generally with sports has become commonplace. Companies like Peloton® have known that adding the ability of cyclists to compete against one another in a virtual spinning class is more likely to increase engagement, keep exercisers engaged and returning, and to enable individuals to be better-equipped to reach their fitness goals.

In a similar space, Zwift® has offered its customers the ability to go on “road” style races within a virtual environment along said that customer's friends. The resulting experience has been a hit. Players arrange to meet up with one another to practice, ride, and even to compete in races. Players may interact with each other both in and outside of the game. Zwift offers a social networking component and feeds somewhat of a traditional trait of many cyclists: competitiveness. That players can see each other's progress, compare statistics, and engage in side-by-side races with athletes hundreds or thousands of miles away offers a unique set of experiences that Zwift's customers enjoy.

Zwift relies upon a virtual game world in which players interact. Players can move through the virtual world, exercising as they go, with their digital avatar representing their position and exercise effort within that world. Other systems rely upon video classes with instructors in the form of rowing instruction, spinning instruction, weight training, and the like. Typically, these experiences are shown on a display in front of the exercising individual.

To enable Zwift and other, similar, exercise systems to function and ensure a relative uniformity of experiences for its riders, Zwift is primarily reliant upon so-called “trainers.” Trainers are devices that apply resistance to purpose-mounted outdoor cycles or to purpose-built indoor cycles. Typically, a trainer will replace the back wheel of a traditional, outdoor bicycle. In some cases, a trainer will rely upon a roller engaging with a back wheel of a traditional, outdoor bicycle. A trainer is distinguished from an indoor cycle in that it is designed to be mounted to any number of outdoor cycles to thereby create a resistance bicycle where previously there was only a traditional two-wheeled, outdoor bicycle. Without fail, when the word “trainer” is used herein, a so-called “smart” trainer is intended-meaning a trainer that can vary its resistance as directed by software operating on a computing device in communication with that trainer.

Increasingly, Zwift is also operable with purpose-built indoor cycles that are, in essence, trainers permanently (or temporarily) mounted on a “bicycle” (which may or may not have two wheels) and which is designed for the integration of a resistance device. Zwift and other software systems can function in much the same way with other variable, computer-controlled resistance exercise systems. These can include rowing machines, treadmills (though this is not usually resistance, it is typically speed and incline adjustment), resistance weight machines, and traditional indoor cycles. Any exercise device that operates using software-controlled resistance or variable speed could be controlled using the protocol described herein.

In addition, manufacturers are increasingly adding functionality to these rides. Most riders use a fan, primarily simply to keep themselves cool. Riding can be intense. But, there are fans that simulate the speed at which a rider is moving in an exercise. Likewise, there are front-mounted devices that raise and lower the front of a mounted bicycle to simulate going up and down hills. Still other devices simulate “lean” as a rider leans into a turn to try and better simulate the virtual environment. Shifting gears is common in cycling, downshifting to go up hills and upshifting to go down. Increasingly, indoor cycles and trainer-mounted cycles incorporate shifters, both wireless and physically connected by wires. Rowing machines can simulate currents or rougher waters. Treadmills can incline or decline to simulate road conditions.

One element that is relevant here is that the system utilizes software to control resistance or speed or other characteristics. In some of those cases, the same company controls the entire system (e.g. Peloton). However, in other cases the software must designed to be able to communicate with various exercise devices which may be connected to the software. In such a case, a uniform communication protocol may be advisable. Bluetooth® low energy protocol exists and enables energy-efficient data transmission, but its capabilities are limited. Likewise, FTMS (Fitness Machine Service) protocol is available. However, its capabilities are also limited as it was designed some time ago and the numerous elements set forth above (e.g. incline or lean or shifting) were not expected. It would be beneficial if there were a protocol designed with present software-controlled exercise in mind and with the option for expandability in the future. It would be beneficial if the protocol would reduce overall latency, while being more robust, and conserving power. It would likewise be beneficial if the software device could operate as a central communication hub through which all connected devices communicate.

### DESCRIPTION OF THE DRAWINGS

FIG. 1 is an overview of an exercise device communications system.

FIG. 2 is a functional diagram of an exercise device communications system.

FIG. 3 is a functional diagram of a computing device.

FIG. 4 is an example of an exercise device.

FIG. 5 is an example of a handheld controller pair.

FIG. 6 is flowchart of a process of communication using a communications protocol.

FIG. 7 is a process flow for a communications protocol of a client write and a server indication.

FIG. 8 is a process flow for a communications protocol of a server notification.

FIG. 9 is a flowchart of a process of communications in an exercise device communications system.

Throughout this description, elements appearing in figures are assigned three-digit reference designators, where the most significant digit is the figure number where the element is first introduced and the two least significant digits are specific to the element. An element that is not described in conjunction with a figure may be presumed to have the same characteristics and function as a previously described element having the same reference designator.

### ASPECTS OF THE DISCLOSURE

Non-limiting aspects of the disclosure are set out in the following numbered clauses.

1. A system for controlling an exercise device, the system comprising:
a gear shifting device, the gear shifting device having a first communications interface for communicating with computing devices;
a computing device comprising:
   a processor executing software which when executed by the processor generates a virtual world in which exercise is simulated,
   a second communications interface for communicating with accessory devices, and
   a third communications interface for communicating with resistance devices;
a resistance device, including a fourth communications interface for communicating with the computing device, the resistance device for applying resistance to an exercising individual operating the exercise device as directed by the software;
wherein a gear shift instruction is transmitted using the first communications interface of the gear shifting device to the second communications interface of the computing device; and
wherein a resistance instruction, which is based on the gear shift instruction, is transmitted by the third communications interface to the fourth communications interface of the resistance device.
   2. The system of clause 1 wherein the resistance instruction sent by the third communications interface to the fourth communications interface is first generated by translating the gear shift instruction into a succession of resistance settings for the resistance device to simulate a selected one of: a gear shift, application of a brake, and a texture of a road or environment within the virtual world simulated by the software,
or,
   the resistance instruction comprises the gear shift instruction.
   3. The system of any preceding clause wherein the resistance device is a selected one of a bicycle trainer, an indoor bicycle, a rowing machine, a resistance weight machine, and a treadmill.
   4. The system of any preceding clause wherein the gear shift instruction is an instruction to change a gear ratio associated with the exercise device and being simulated by the resistance device as directed by the software to simulate exercise within the virtual world.
   5. The system of any preceding clause wherein the gear shifting device is a selected one of:
a remote control,
a video game controller,
an electronic or manual gear-shifting lever or group of levers, and
a specially-designed controller for use with at least one of the exercise device, the resistance device, and the software.
   6. The system of any preceding clause wherein the gear shift instruction received by the computing device is a selected one of:
an indication of a particular gear selection to which to transition the resistance device; and
an indication of either a desire to shift up or down one gear from a gear presently in use by the resistance device to another gear.
   7. The system of clause 6 wherein the gear shift instruction is translated by the computing device before transmission to the resistance device into a selected one of:
a numerical resistance to be applied by the resistance device;
a percentage reduction or increase in resistance to be applied by the resistance device; and
a numerical reduction or increase in resistance to be applied by the resistance device.
   8. A system for controlling an exercise device, the system comprising:
a remote control device, the remote control device having a first communications interface for communicating with computing devices;
a computing device comprising:
   a processor executing software which when executed by the processor generates a virtual world in which exercise is simulated,
   a second communications interface for communicating with accessory devices, including the remote control device, and
   a third communications interface for communicating with resistance devices;
a resistance device, including a fourth communications interface for communicating with a computing device, the resistance device for applying resistance to an exercising individual operating the exercise device as directed by the software;
wherein a resistance altering instruction is transmitted using the first communications interface of the remote control device to the second communications interface of the computing device; and

wherein a resistance instruction, which is based on the resistance altering instruction, is transmitted by the third communications interface to the fourth communications interface of the resistance device.

9. The system of clause 8 wherein the resistance instruction sent by the third communications interface to the fourth communications interface is generated by translating the resistance altering instruction into a succession of resistance settings for the resistance device to simulate a selected one of: a gear shift, application of a brake, and a texture of a road or environment within the virtual world simulated by the software,
or,
   the resistance instruction comprises the resistance altering instruction.
   10. The system of clause 8 or clause 9 wherein the resistance device is a selected one of a bicycle trainer, an indoor bicycle, a rowing machine, a resistance weight machine, and a treadmill.
   11. The system of any of clauses 8 to 10 wherein the resistant altering instruction is an instruction to change a gear ratio associated with the exercise device and being simulated by the resistance device as directed by the software to simulate exercise within the virtual world.
   12. The system of any of clauses 8 to 11 wherein the remote control device is a selected one of: a remote control, a video game controller, an electronic or manual gear-shifting lever or group of levers, and a specially-designed controller for use with at least one of the exercise device, resistance device, and the software.
   13. The system of any of clauses 8 to 12 wherein the resistance altering instruction received by the computing device is a selected one of:
an indication of a particular gear selection to which to transition the resistance device;
an indication of either a desire to shift up or down one gear from a presently-selected gear selection by the resistance device;
a request to apply a selected amount of braking force by the resistance device;
a request to apply a selected intermittent signal, embodying a simulated road surface, by the resistance device.
   14. The system of clause 13 wherein the resistance altering instruction is translated by the computing device before transmission to the resistance device into a selected one of:
a numerical resistance to be applied by the resistance device;
a percentage reduction or increase in resistance to be applied by the resistance device;
a numerical reduction or increase in resistance to be applied by the resistance device;
a series of numerical resistances to be applied by the resistance device; and
a waveform or portion thereof describing a variable resistance over a period of time to be applied by the resistance device.
   15. A computing device for controlling an exercise device, the computing device comprising:
a processor executing software which when executed by the processor generates a virtual world in which exercise is simulated;
a first communications interface for communicating with an accessory device; and
a second communications interface for communicating with a resistance device for applying resistance to an exercising individual operating the exercise device as directed by the software;
wherein the computing device is configured to receive a resistance altering instruction from the accessory device via the first communications interface; and
wherein the computing device is further configured to transmit a resistance instruction, that is based on the received resistance altering instruction, to the resistance device via the second communications interface.
   16. The computing device of clause 15, further configured to generate the resistance instruction using the received resistance altering instruction.
   17. The computing device of clause 15 or clause 16, wherein the accessory device is a gear shifting device, and wherein the resistance instruction is a gear shift instruction.
   18. A method for controlling an exercise device, the method comprising:
receiving, from an accessory device, a resistance altering instruction via a first communications interface; and
transmitting a resistance instruction, that is based on the received resistance altering instruction, to a resistance device via a second communications interface.
   19. The method of clause 18, further comprising:
generating the resistance instruction using the received resistance altering instruction.
   20. The method of clause 18 or 19, wherein the accessory device is a gear shifting device, and wherein the resistance instruction is a gear shift instruction.
   21. A computer program configured to perform the method of any of clauses 18 to 20 when executed on one or more processors.
   22. A system for control of a resistance device, the system comprising:
the resistance device in communication with a computing device executing software to simulate a virtual environment in which exercise may take place with resistance for the exercise provided by the resistance device as directed by the software;
the computing device comprising a processor and memory, the processor executing the software to generate the virtual environment in which a user may engage in the exercise;
a remote control, the remote control in communication with the computing device for providing resistance setting signals to the computing device; and
wherein the resistance setting signals are translated by the computing device into a resistance control signals by the computing device which is then transmitted to the resistance device to alter the resistance applied by the resistance device.
   23. The system of clause 22 wherein the resistance control signals is an instruction causing the resistance device to simulate a selected one of: a gear shift, application of a brake, and a texture of a road or environment within the virtual world simulated by the software.
   24. The system of clause 23 wherein the resistance device is a selected one of a bicycle trainer, an indoor bicycle, a rowing machine, a resistance weight machine, and a treadmill.
   25. The system of clause 23 or clause 24 wherein the remote control is a selected one of: a handlebar mounted remote, a video game controller, an electronic or manual gear-shifting lever or group of levers, and a specially-designed controller for use with at least one of the exercise device, resistance device, and the software.
   26. The system of any of clauses 23 to 25 wherein the resistance setting signals instruction received by the computing device is a selected one of:
an indication of a particular gear selection to which to transition the resistance device;
an indication of either a desire to shift up or down one gear from a presently-selected gear selection by the resistance device;
a request to apply a selected amount of braking force by the resistance device;
a request to apply a selected intermittent signal, embodying a simulated road surface, by the resistance device.
   27. The system of clause 26 wherein the resistance control signals is translated by the computing device before transmission to the resistance device into a selected one of:
a numerical resistance to be applied by the resistance device;
a percentage reduction or increase in resistance to be applied by the resistance device;
a numerical reduction or increase in resistance to be applied by the resistance device;
a series of numerical resistances to be applied by the resistance device; and
a waveform or portion thereof describing a variable resistance over a period of time to be applied by the resistance device.

### DETAILED DESCRIPTION

### Description of Apparatus

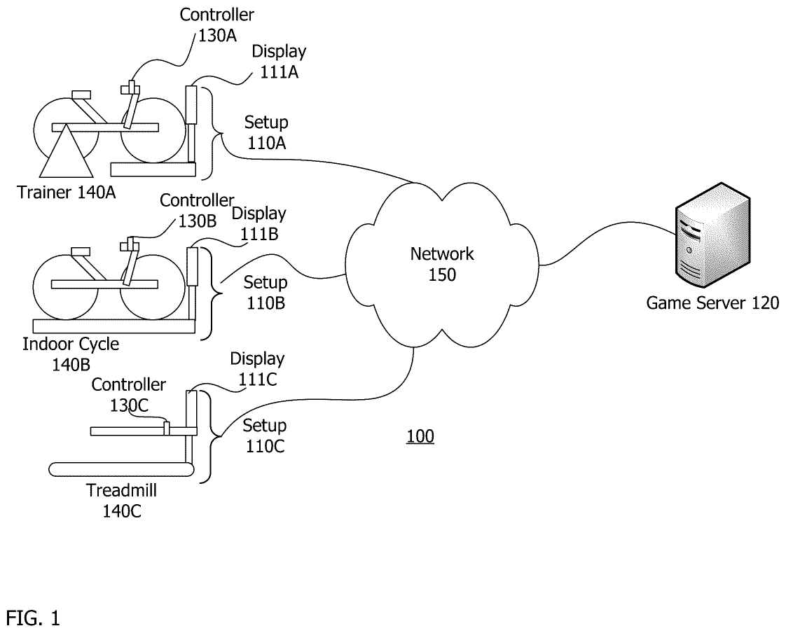

FIG. 1 is an overview of an exercise device communications system 100. The system 100 includes a series of setups 110A, 110B, and 110C, a game server 120, a series of controllers 130A, 130B, and 130C, a trainer 140A, an indoor cycle 140B, and a treadmill 140C, all interconnected by a network 150.

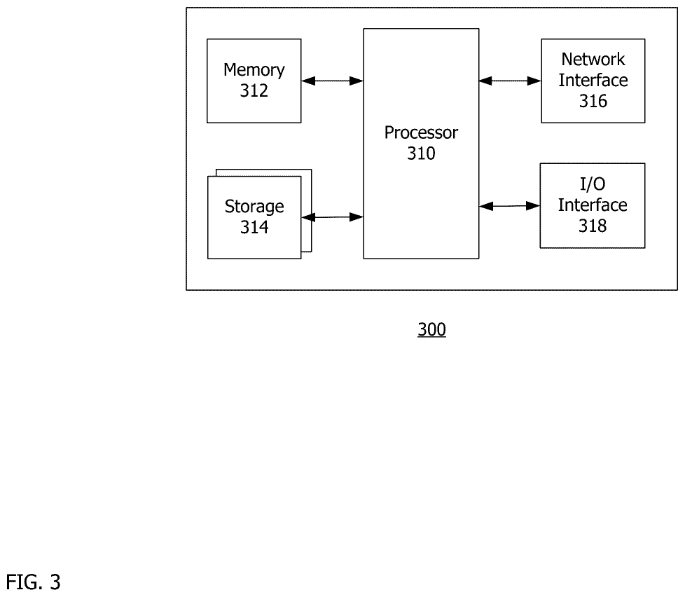

The setup 110A is made up of the display 111A, controller 130A, and trainer 140A. A setup as used herein means a complete set of equipment to engage in exercise. The display 111A is at least a display for showing an ongoing exercise routine, class, or gamified world in which exercise is taking place. Preferably, the display 111A is likewise a computing device (FIG. 3) capable of executing software to enable the exercise routine, class, or gamified world to be displayed. If the display 111A is not itself a computing device, then the display 111A must be in communications with a computing device to accomplish those tasks. The computing device is an integral part of a setup, like setup 110A

The setup 110B is similar to setup 110A except that there is no trainer used. Instead an indoor cycle 140B is used here. Display 111B and controller 130B are likewise present with similar functions discussed above and below.

The setup 110C is similar to setups 110A and 110B, except a treadmill 140C is used here. Display 111C and controller 130C are likewise present with similar functions discussed above and below.

The game server 120 is a computing device operating software which maintains the state of all connected players (or class participants). The game sever 120 preferably enables setups 110A, 110B, and 110C to connect thereto to engage in exercise as directed by the game server 120. The game server 120 may merely serve spinning classes or similar classes in video form as a streaming device (or a plurality of streaming devices). Or, the game server 120 may act very much like a game server in a non-exercise context, enabling authenticated connection by users to engage with a virtual world to which the setups 110A, 110B, and 110C connect to participate. The game server 120 may be a single computing device but is preferably a scalable cloud service with multiple computing devices in various locations throughout the world.

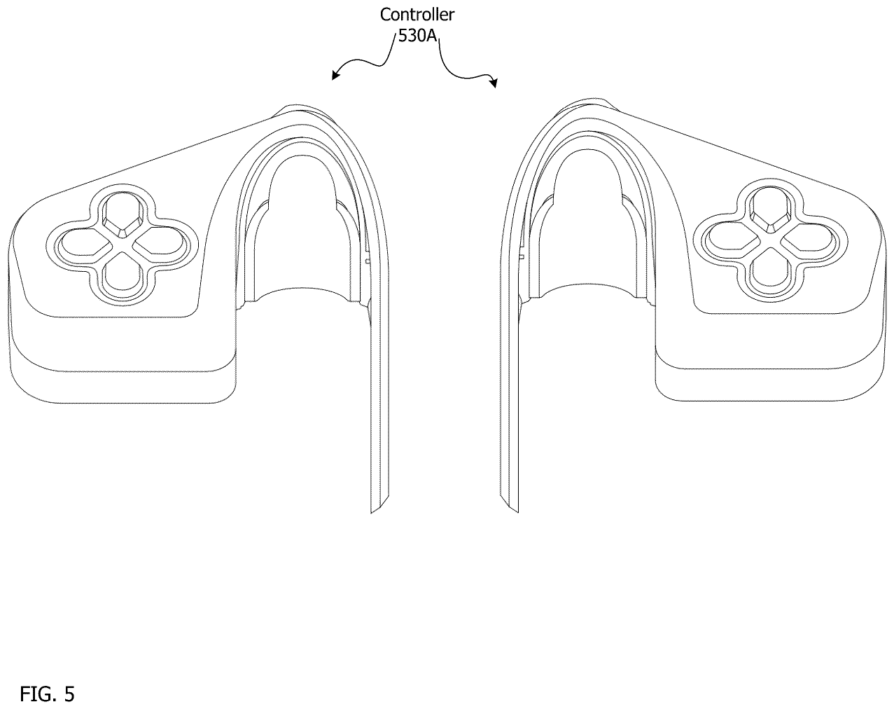

The controllers 130A, 130B, and 130C are remote control devices that operate in conjunction with software operating on the display 111A, 111B, or 111C to control some aspect of the respective setup. Controllers 130A, 130B, and 130C (FIG. 5) operate, for example, to send signals adjusting the resistance applied by the trainer 140A, indoor cycle 140B, or the speed of the treadmill 140C. Controllers 130A-130C may include joysticks or motion controllers and can be used to steer through a virtual world or to select one or more elements within the software operating on the displays 111A-111C.

The trainer 140A is a resistance device that applies resistance (or negative resistance-acceleration) to the setup 110A. The trainer 140A is in communication with the software operating on the computing device (e.g. in the display 111A) to alter the resistance applied as directed by the software. In the case of Zwift, the resistance may be increased as a rider's virtual avatar ascends a hill within the game. Alternatively, the rider's resistance may be decreased as a rider descends a hill, obtains a power-up, or drafts behind another rider. Braking or gear shifts may be simulated—as directed by the software—to correspond to signals indicating those changes. So, for example, the controller 130A may indicate to the software that a gear shift has been entered. If so, the trainer 140A may be directed by the software operating on the display 111A to simulate a gear shift or to actually engage a physical gear shift if a physical set of gears is present.

The indoor cycle 140B and treadmill 140C operate substantially the same as trainer 140, but the indoor cycle 140B is integrated into the setup 110B and the treadmill 140C alters speed and incline, but not resistance, but otherwise operates in a similar manner to the trainer 140A in setup 110A.

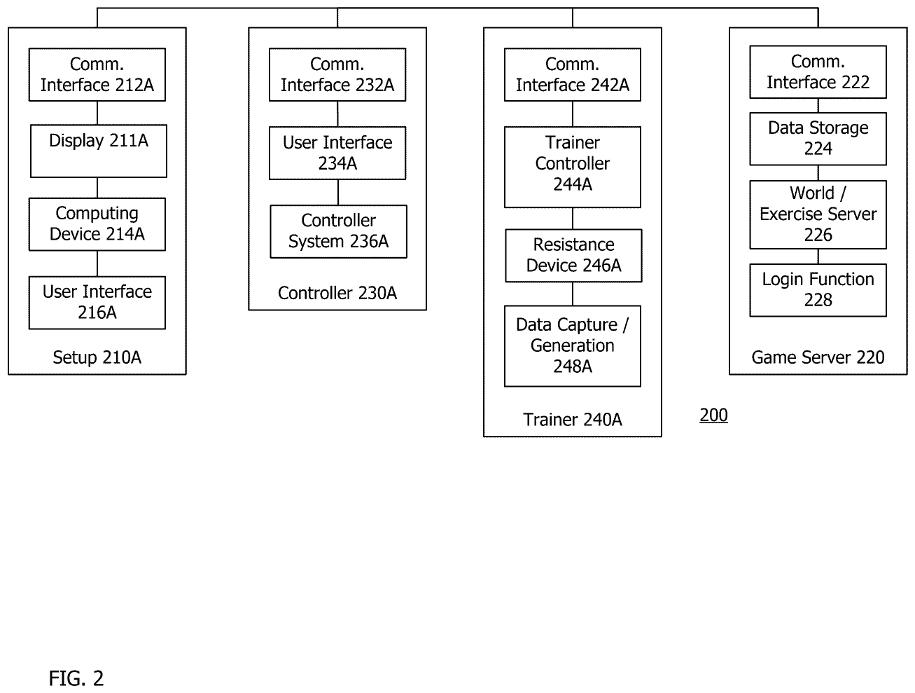

FIG. 2 is a functional diagram of an exercise device communications system 200. The system 200 includes one of the setups, setup 210A, game server 220, controller 230A, and trainer 240A. The other two setups 110B and 110C would operate similarly to those described in FIG. 2 and will not be described separately here.

The setup 210A includes the display 211A, communications interface 212A, a computing device 214A, and a user interface 216A. The communications interface 212A is a software/hardware interface that enables the setup 210A to communicate with the game server 220, controller 230A and the trainer 240A. The particular hardware and/or protocol used for each communication may be different. So, for example, the controller 230A may communicate with the setup 210A using a short range wireless communications protocol such as Bluetooth®, or may be wired (for example, via USB) or may rely upon a local area wireless network protocol such as 802.11x. Other hardware connectivity options are available as well. However, the same communications protocol may be used over whatever hardware channel or carrier is used.

The communications interface 212A relies upon a modified Bluetooth Generic Attribute (GATT) profile. The Service UUID (universally unique identifier) for the new protocol described herein is 00000001-19CA-4651-86E5-FA29DCDD09D1. It is beneficial over existing options such as FTMS (Fitness Machine Service) protocol in including more expandability, greater options for back-and-fort communications, and being more secure, while also lowering overall bandwidth usage. A GATT profile identifies a particular Bluetooth communication transport protocol. If two devices interact that share a GATT profile, then they are able to communicate using that profile once it has been identified and a handshake process has completed.

The new protocol described in this disclosure is configured as a GATT Primary Service having three channels for communication: an asynchronous channel, a synchronous receive (RX) channel and a synchronous transmit (TX) channel. The asynchronous channel is primarily used for notification and therefore uses the NOTIFY property of the Bluetooth GATT profile. The asynchronous channel does not confirm receipt of any data sent using the channel and the data is sent in a stream on an as-needed basis. The RX channel uses the WRITE property of GATT Bluetooth and the RX channel uses the INDICATE property of GATT Bluetooth. These two channels rely upon sending data and expecting confirmations of receipt. Accordingly, only data which requires confirmation is sent using one of these wo channels. This protocol is defined in detail by Appendix A, attached hereto and incorporated by reference in its entirety. For purposes of this disclosure, no matter the hardware connection methodology or the bearer packet, the protocol described herein will be formed as set forth above and in Appendix A.

The Primary Service above may be characterized:

| | | Mandatory | Optional | | Maximum |
|---|---|---|---|---|---|
| Name | 16-bit UUID | Properties | Properties | Security | Length |
| Async | 0x0002 | NOTIFY | — | None | 128 |
| Sync RX | 0x0003 | WRITE | — | None | 128 |
| Sync TX | 0x0004 | INDICATE | — | None | 128 |

The simultaneous use of the RX, TX and asynchronous channels enables messages that require no response to simply be “streamed” from the server to the client via the asynchronous channel. In this way, the client need not confirm receipt as is typical with TCP/IP communications or with usual Bluetooth low energy. The types of messages sent on the asynchronous channel may be low-priority or may be repeated or altered frequently enough that confirmation is not required. As a result, energy is conserved by not handling all of the back-and-forth control messages for this type of communication. Simultaneously, the RX and TX channels can be used for data or information or notifications that must be acknowledged and typically must result in some change in the client and/or server. These operate in a much more traditional manner in this context, but are utilized only for critical communications between the client and/or server

The three channels, RX, TX, and asynchronous, are capable of simultaneous engagement and operation such that data may be sent and/or received on any one or all of the three of the channels simultaneously or substantially simultaneously with one another. In practice, the channels may never be used exactly at the same time as one another. However, they will each be used throughout a connection between a server device and a client device to send and/or receive messages of the respective types identified herein for each channel. This configuration may entail having each of those channels available for use at the same time—e.g. simultaneously or substantially simultaneously with one another. As such, each of these channels may be configured to be open for simultaneous communication. As used herein, the phrase “substantially simultaneously” means taking place within 1000 milliseconds of each other.

The packet format for when Bluetooth® is used to carry the protocol is:

| Protocol Opcode | Protocol Message PDU |
|---|---|
| 1 Byte | 0 to (BLUETOOTH_MAX_PACKET_LENGTH - 1) |
| | bytes |

Where BLUETOOTH_MAX_PACKET_LENGTH is defined as 240.

The packet format for when USB composite device class (CDC) is used to carry the protocol is:

| Data Length | Opcode | Protocol Message PDU |
|---|---|---|
| 1 Byte | 1 Byte | 0 to (USB_MAX_PACKET_LENGTH - 2) |
| | | bytes |

Where USB_MAX_PACKET_LENGTH is defined as 128.

The packet format for when USB iAP2 (iPod Accessory Protocol 2) (e.g. for use with iPhones and iPads) is used to carry the protocol is:

| Data Length | Opcode | Protocol Message PDU |
|---|---|---|
| 1 Byte | 1 Byte | 0 to (USB_MAX_PACKET_LENGTH - 1) |
| | | bytes |

Where USB_MAX_PACKET_LENGTH is defined as 128.

The packet format for when internet protocol (IP) (e.g. for use with ethernet, or 802.11x wireless) is used to carry the protocol is:

| Data Length | Opcode | Protocol Message PDU |
|---|---|---|
| 1 Byte | 1 Byte | 0 to (IP_MAX_PACKET_LENGTH - 2) bytes |

Where IP_MAX_PACKET_LENGTH is defined as 128.

The display 211A is described above. Display 211A is primarily to display to a user the ongoing training session or game.

The computing device 214A is preferably a part of display 211A, but in whatever case is in communications with display 211A to provide the ongoing training session or game. The computing device generates a user interface 216A on the display 211A (in the case of a touchscreen) or through other input methods and systems (e.g. buttons, controllers, remote controls, etc.) for the setup 110A.

The game server 220 is a computing device executing software that allows the game server 220 to operate as a communications interface 222, a data storage 224, a world/exercise server 226, and to provide a login function 228.

The communications interface 222 is substantially the same as that described with respect to element 212A above. However, the game server 220 will almost certainly communicate through one or more ethernet cables to an internet pipeline with connectivity to multiple setups, like setup 210A. The data sent and received by the game server 220 using the communications interface 222 is less voluminous than that sent between a setup 210A and controller 230A and trainer 240A, so the communications interface 222 may rely upon traditional TCP/IP datagrams and associated services to communicate with the computing device 214A for a given setup 210A.

The data storage 224 may store such information as the game world environments, textures, and training sessions or competitions to take place in the game world. The data storage 224 may store information about each user (e.g. accomplishments, personal records, etc.) and any competition outcomes involving any users.

The world/exercise server 226 is software operating on a computing device that serves to allow a plurality of setups, like setup 210A, to connect to the game server 220 and engage with the world and engage in exercise. This may be a streaming server of streamed pre-recorded classes for a spinning or running or weight training class. This may be a virtual world to which players connect to use avatars within the game world to move within while engaged in exercise. Various forms of this world/exercise server 226 may be envisioned.

The login function 228 may use the data storage 224 to store authentication information suitable to ensure security of the game server 220 and to ensure that setups, like setup 210A, that connect to the game server 220 have paid an associated membership fee and are otherwise authorized to access the game server 220. The login function 228 may ensure that users are authenticated and are able to access the game server 220.

The controller 230A includes a communications interface 232A, a user interface 234A, and a controller system-on-a-chip 236A. The communications interface 242A operates substantially the same as communications interface 212A. However, preferably, the communications interface 232A of the controller 230A acts as a Bluetooth low energy server reliant upon the GATT profile which defines the protocol disclosed herein (referred to herein as a “GATT server”), while the communications interface 212A of the setup 210A operates as the counterpart (referred to herein as a “GATT client”) client. The controller may communicate with software executing on the computing device 214A to implement the communications interface 212A to control various functions, including functions of the trainer 240A. Notably, the controller 230A generally does not communicate directly with the trainer 240A.

The user interface 234A of the controller 230 may be one or more buttons, joy sticks, analog sticks, triggers, motion controls, touchscreen display control implemented in software, or other controls implemented on the controller 230A. In a preferred embodiment, the controller 230 is one or more video game system-like controllers used to engage in specific functions with respect to the game or other software operating on the computing device 214A of the setup 210A. The controller may take the form of a traditional brake lever for a bicycle and/or a traditional gear shift lever, ratchet, or trigger, which may be translated into digital signals transmitted over the communications interfaces 232A, 212A to cause the computing device 214A to instruct the trainer 240A to operate accordingly.

The controller system 236A is a computing device (FIG. 2) responsible for operating as a GATT server and instructing the communications interface 232A what signals to transmit to the setup 210A. In more complex systems, the SoC 236A may perform other functions such as rendering a display, translating touch contact, detecting and interpreting motion of the controller 230A or the like.

The trainer 240A includes a communications interface 242A, a trainer system-on-a-chip 244A, a resistance device 246A, and data capture/generation 248A. The communications interface 242A performs substantially the same function as the communications interface 232A of the controller 230A. As with the controller 230A, the trainer 240A communications interface 242A generally does not communicate directly with any other device except the associated setup 210A communications interface 212A.

The trainer controller 244A is a computing device that operates to intelligently control the trainer 240A as directed by software operating on the setup 210A. The trainer SoC 244A also enables the protocol to be transmitted and received via the communications interface 242A.

The resistance device 246A is a device to add resistance (or negative resistance) to a moving object (e.g. a wheel or axle). The resistance device 246A is described as a “resistance” device, but could merely add speed or simulate weight in the case of pulley-based, weight training. There exist other resistance devices such as air or water resistance (e.g. used in rowing machines), but for a number of reasons eddy current brake is typically the chosen resistance device 246A no matter the type of exercise being simulated.

The data capture/generation 248A may be a part of the trainer SoC 244A, but in general is functions designed to capture the data associated with the ongoing exercise and to send that data (using the communications interface 242A) back to the setup 210A for eventual transmission to the game server 220 to update the game and/or race and/or training session. The types of data captured may be speed, cadence relative to the applied resistance, the amount of force by the user, or similar information. Associated sensors may be used (e.g. force sensors) or the data may be calculated from available variables (e.g. force, speed, cadence, etc.).

Turning now to FIG. 3, a block diagram of a computing device 300 is shown. The computing device 300 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 300 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

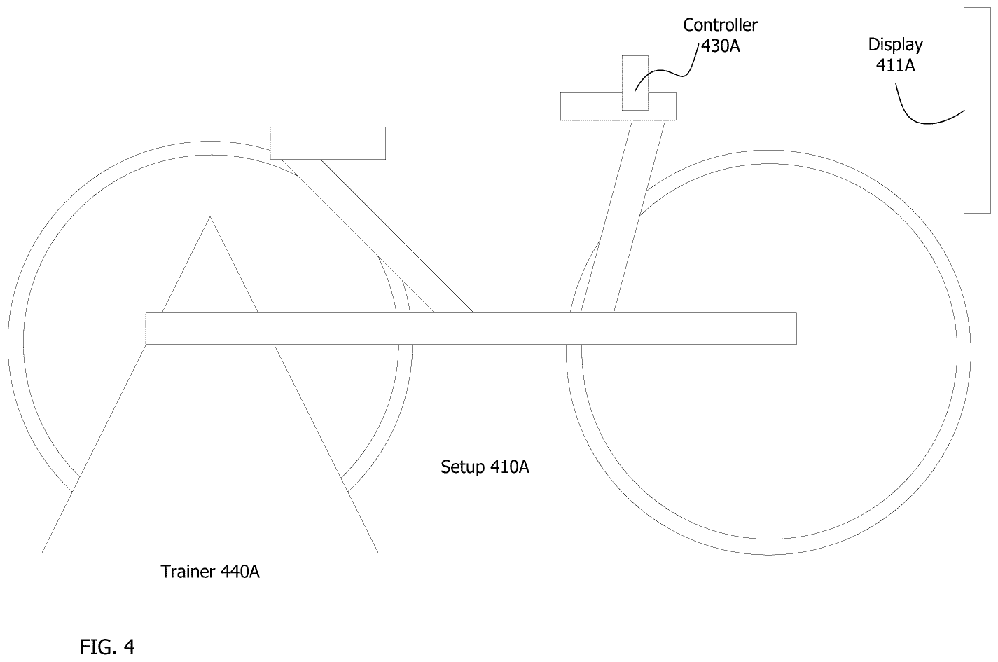

FIG. 4 is an example of an exercise device setup 410A which may be the setup 110A or 210A. The setup 410A includes a display 411A, a controller 430A, and a trainer 440A. Setups B and C (shown in FIG. 1) are not discussed with reference to FIG. 4 as their functions are not substantially distinct therefrom). The display 411A is shown in front of a rider. The controller 430A may be, for example, attached to the handlebars of the setup 410A. Though shown as a brake or shift controller, the controller 430A may take different forms in different exercises or setups. And, though discussed as a “controller” the same communications protocols may be used with other devices that operate in some sense as a “controller” but may not take that form. For example, the same devices that provide a tilt function for bicycles or treadmills to simulate uphill or downhill rides/runs may in some sense be a “controller” as discussed herein in the sense that they communicate with the computing device 214A of the setup 210A in the same way as a controller, using the same protocols. Automatically controlled fans, side-to-side lean hardware, and other, similar hardware may likewise be a “controller,” as disclosed herein, reliant on the same communications protocol.

The trainer 440A is a trainer as discussed above. The trainer 440A may likewise rely upon the same communications protocol described herein.

FIG. 5 is an example of a handheld controller 530A pair. Here, the controller is designed to sit on handlebars of a bicycle and to provide triggers on the back of the controller, with a traditional “d-pad” controller on the front/top of the controller. Controllers of various forms may be used without departing from the intended scope of the communications protocol used herein or the relay-like functionality of ensuring that the controller 530A communicates with the software operating the game world on the setup 410A, rather than directly with, for example, the trainer 440A.

### Description of Processes

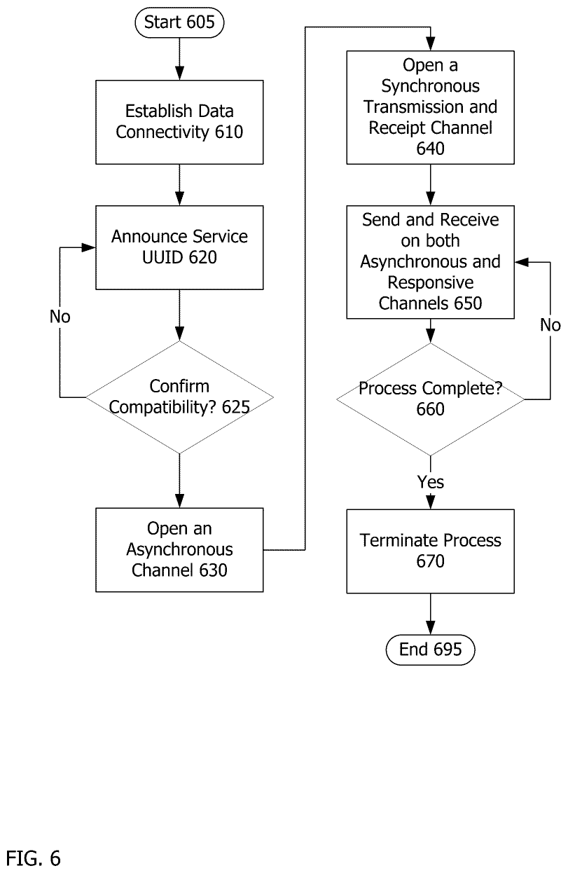

FIG. 6 is flowchart of a process of communication using a communications protocol. The process begins at 605 and ends at 695. The process takes place for each communications device reliant upon the protocol and ends when the device is disconnected or the process terminates.

Following the start 605, the process begins with establishment of connectivity at 610. Here, the transport layer is allocated and connected by both the client and the server. In a typical case, the controller device will operate as the server and the computing device of the setup (e.g. setup 210A of FIG. 2) will operate as the client for this protocol. This step is merely to establish the transport bearer for the protocol to communicate.

Thereafter, the UUID is announced by the server at 620. Here, the server announces its availability to serve as a server for the protocol and searches for compatible responses from available clients. If no suitable response is received (“no” at 625), then the process continues with ongoing announcements.

If a suitable response indicating compatibility is received (“yes” at 625), then the process continues with the opening of the asynchronous channel at 630. This channel is used for data that is simply sent in a stream to the client. This data is typically from a device operating as a control device for the world and/or other attached devices (e.g. trainers). The important characteristic of this channel is that notifications sent on this channel require no response from the client. Examples of such communications include: notifications from the exercise device, notifications from the software to the exercise device, event flagging messages, notifications from a controller device, notifications from a battery device, notifications indicating wireless internet status, lighting and sound effect event status notifications, intermediate game state events, notifications from a secondary controller device, notifications related to a battery status of a secondary exercise device, notifications that the secondary exercise device has paired with the software, notifications that the exercise device or the secondary exercise device has engaged a virtual gear shift process in software, notification regarding a spindown of the exercise device or a secondary exercise device, and notification that the software has lost control over the exercise device or secondary exercise device.

Next, a synchronous transmission (TX) channel and a synchronous receipt (RX) channel are opened at 640. The transmission (TX) channel is setup on the client device, the receipt (RX) channel is setup on the server device to receive notifications from the client device(s). These two channels operate in a mode wherein an acknowledgement is expected in the general form of an ACK/NACK or other response indicating or confirming receipt of the message. This is unlike the asynchronous channel where no response is expected. This is typically because receipt of or response to the data is not necessary for ongoing operation of a device to which the message of this type is sent.

The TX channel is used for the server to respond to a connected client. Examples of TX channel responses include: a setting for the server device set by the software, a setting for the software necessary for the exercise device to operate, a request to have the server device operate as a bridge between the software and a third device, a request to have the server device power off, a calibration setting for a touch surface controlled by the server device, a calibration setting for the server device or an exercise device, a request to reset the server device, a request to cause a lighting element to have a selected setting, animation, or status, a request to set a setting for the exercise device, a request to set one or more settings for the exercise device, and a request to begin a spindown of the exercise device.

The RX channel is used to receive messages from a connected client. Examples of RX channel requests include: a notification regarding development information or status from the software, a notification regarding a configuration of the exercise device, a status of an ongoing data transfer from the server device to the client device, a notification of the status of lighting elements controlled by the exercise device, a notification on the diagnostic status of the exercise device, a notification of the status of a battery associated with the exercise device, a notification of a version of the exercise device, a notification regarding the SSID of a wireless network, a notification of a version of a secondary exercise device, a notification regarding an error in lighting elements controlled by the exercise device, a notification regarding the status of a setting of the exercise device or the secondary exercise device, a notification regarding a touch surface associated with the exercise device or the secondary exercise device, a notification regarding an updating status for firmware updates to the exercise device or the secondary exercise device, notifications from a log associated with the exercise device or the secondary exercise device, notifications indicating a fault with the exercise device or the secondary exercise device, notification regarding a calibration or calibration status for the exercise device or the secondary exercise device, notifications indicating that a firmware update has completed and is now locked, notifications related to information for the secondary exercise device, notifications identifying a particular version of the secondary exercise device, and notifications indicating that the three-part communication connection is supported by the server device.

The process continues with both channel types being open on all three channels. So, sending messages takes place on the asynchronous channel\ while sending and receiving messages on the RX and TX channels takes place at 650. These communications continue while the exercise device (e.g. a controller) is connected to the computing device.

If the process continues (“no” at 660), meaning that the exercise is ongoing or the device remains connected, then the channels remain open and transmitting and receiving.

If the process is complete (“yes” at 660), then the process is terminated at 670. Here the device maybe disconnected, or all devices may be powered off. Or the exercise may complete and the controller may disconnect to conserve power.

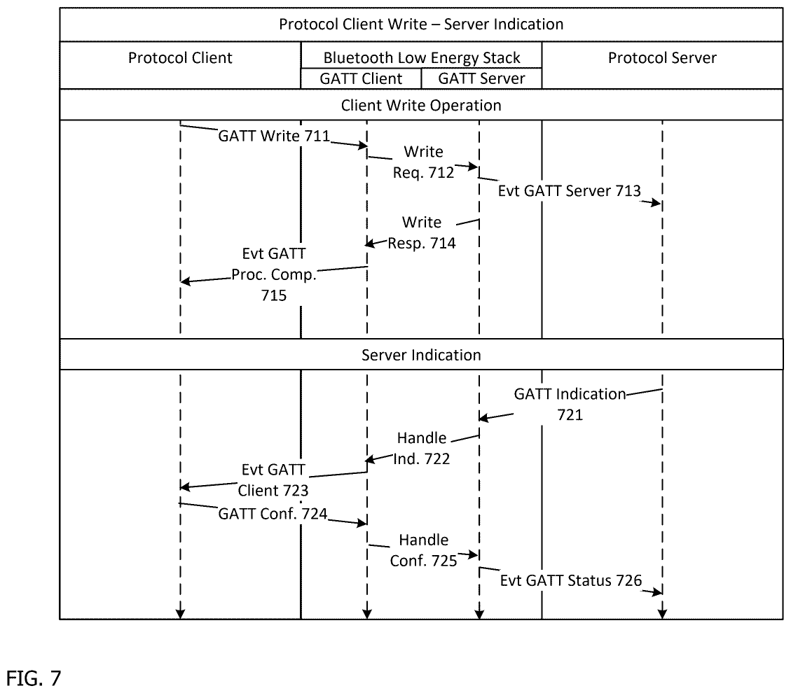

FIG. 7 is a process flow for a communications protocol of a client write and a server indication. FIG. 7 includes two different examples of acknowledged communications. First, a client write operation is shown, beginning with a client requesting a GATT write at 711. The write request is encapsulated using the Bluetooth® low energy typical communication stack and a write operation is requested at 712. This is the client device (e.g. the software running Zwift) writing to the server (e.g. a controller device or potentially a trainer device). The GATT write 712 is received and the server determines that it is a GATT write event 713 which then completes the write. This data may be the software instructing the controller on a data setting or calibration setting, for example.

Then, the GATT write response 714 is sent by the Bluetooth low energy stack at 714. This is an acknowledgement of the requested write by the client. The client then receives the event indicating that the GATT process is complete at 715. The portions outside the Bluetooth low energy stack are defined by the negotiated GATT. The portions inside the Bluetooth low energy stack are merely the transport layer packaging the GATT operations communications for transmission and receipt. This process relies upon the RX acknowledged channel.

The next example operation is a server indication. Here, the server (e.g. a controller) is providing a data element to the client (e.g. the software) using the protocol. First, a GATT indication is sent through the Bluetooth low energy stack at 721. The GATT handle indication is sent at 722. At the client (e.g. the software), the GATT event is provided to the client at 723. This may be, for example, an indication of a button press or a data element (e.g. a calibration setting). The GATT expected confirmation is sent at 724 for handling through the Bluetooth low energy stack. This confirms that the GATT event, one requiring confirmation, is now completed by the client. This GATT handle confirmation by the Bluetooth low energy stack and is transmitted to the server at 725. Then, the expected GATT event status is received at 726, confirming that the indication has been received and need not be sent a second time. This process relies upon the TX acknowledged channel.

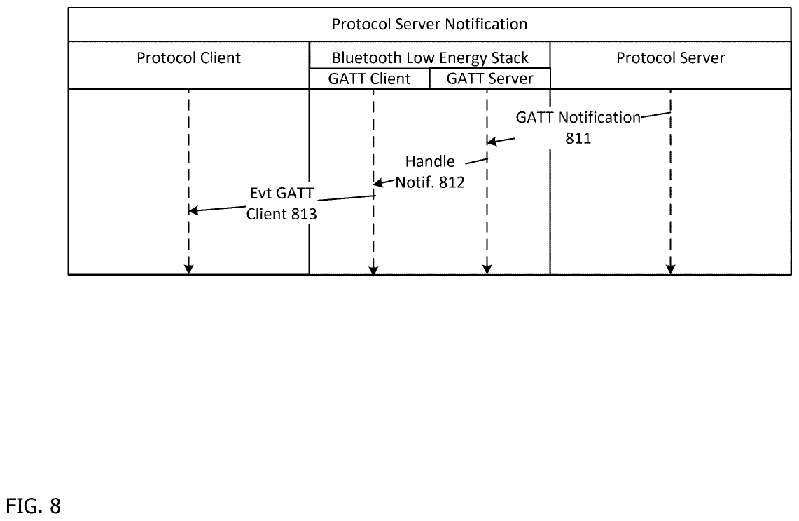

FIG. 8 is a process flow for a communications protocol of a server notification. This is in contrast to the RX and TX channel usage above in FIG. 7 and relies only upon the asynchronous channel. Here, this is merely a notification and, in general, a notification is low enough priority and merely useful information rather than critical information, that it may be streamed and need not be acknowledged.

Here, a GATT notification is sent by the server (e.g. a controller or trainer) at 811. The notification may be a button press on a controller or a change in speed of a trainer or bicycle. The GATT handle notification is handed to the Bluetooth low energy stack for transmission which is at 812. The message is thereby transmitted from server to client. Then, the client's receipt of the expected GATT event is handled by the client at 813. If the message is received (likely), then the process continues with that new data. If it is not received (unlikely), then the client continues operating as it was before without that message. The message can be re-sent later or may merely be repeated when the event happens yet again. In either case, the message is not acknowledged by the client.

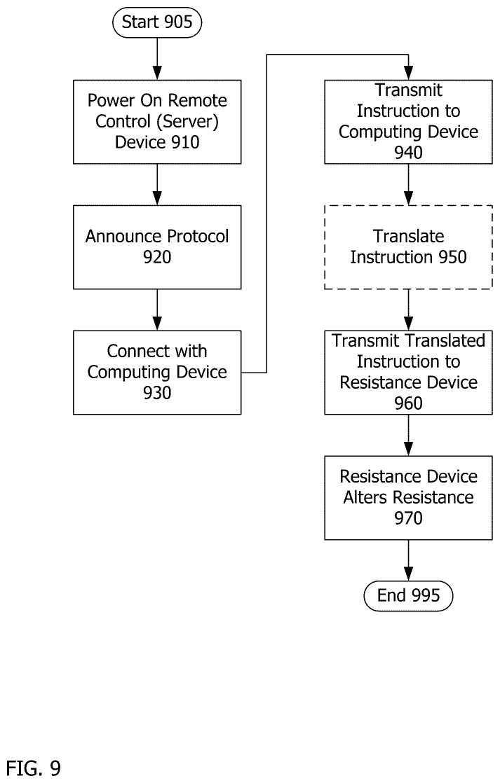

FIG. 9 is a flowchart of a process of communications in an exercise device communications system. The process begins at 905 and ends at 995. This is the generalized process of connection to and use of a control device in conjunction with software. This may be used, for example, in the context of a controller device (or other exercise device) used in connection with a simulated environment such as with Zwift. Preferably, the system relies upon the protocol for communication described above and in Appendix A.

Following the state at 905, the process begins with powering on the remote control (e.g. the server) device at 910. The control includes embedded firmware setting forth its capabilities and its operation, and describing the protocols used for communication with client devices like the software.

Next, the protocol for communications is announced at 920. Here, the server device may continuously and repeatedly announce its protocol(s) used for communication. This enables compatible client devices to discover the server.

Once discovered by the client (e.g. software), the server device is connected to the computing device operating as the client at 930. Here, the controller negotiates the transport bearer (e.g. Bluetooth low energy, USB, 802.11x wireless, or some other connection), then negotiates connection using the protocol. This process may also involve the opening of the TX, RX, and asynchronous channels discussed above.

Once that process is complete, the client and server communications have been set up and the channels may be used for communications.

The server (e.g. a controller) can transmit an instruction for a third device (e.g. a trainer) connected to the computing device (e.g. software operating as a client) at 940. This process may be an indication of a desired reduction or increase in resistance or speed, an instruction to undertake a virtual “gear shift” or a virtual “brake” operation whereby the trainer simulates a change in gear or brake, or may be a request to “steer” the virtual bike or treadmill or an avatar within the virtual world. This instruction is sent by the controller (e.g. server) to the computing device (e.g. software operating on the display 111A).

In the past, many systems with controllers have relied upon the trainer itself or the indoor cycle or the treadmill to operate as the primary hub. Here, however, it is desirable for the computing device—the device operating the associated software for a virtual game world or upon which classes are being offered or streamed—to operate as a hub for all devices to connect. The protocol (Appendix A) may be used for communications with these devices, which each device (e.g. each trainer, each indoor cycle, each trainer, each controller, each “lean” or “tilt” device, and any other fitness-related devices used with the software) connecting to the central computing device operating as the client.

At 940, the instruction may be to “shift gears” virtually and the software is so instructed to do so. That instruction may be transmitted using the protocol described above. That instruction may or may not be suitably formatted for subsequent transmission to a connected trainer device (e.g. a resistance device) to enable appropriate operation.

In such a case, the instruction optionally may be translated at 950 by the computing device (e.g. the software operating on the computing device) to conform to a format desired by the trainer. There are tens of trainers available in the world, there are hundreds of indoor cycles and treadmills. These types of instructions may require formatting to appropriately be transmitted from the receiving client (e.g. the software operating on the computing device) to a second server device operating on the trainer, indoor cycle, treadmill, etc.

The instruction may then be transmitted to the resistance device at 960. As indicated above, the “resistance” device may in fact be a treadmill which merely alters speed, and not resistance. But, in general, this will be the trainer or weight resistance cable system that is being instructed by the controller, through the computing device.

There are various ways in which the instruction may be transmitted to the resistance device at 960. The instruction may be an instruction to apply a selected one of: a numerical resistance to be applied by the resistance device, a percentage reduction or increase in resistance to be applied by the resistance device, a numerical reduction or increase in resistance to be applied by the resistance device, a series of numerical resistances to be applied by the resistance device, or a waveform or portion thereof describing a variable resistance over a period of time to be applied by the resistance device. The instruction may be a selected one of: an indication of a particular gear selection to which to transition the resistance device, an indication of either a desire to shift up or down one gear from a presently-selected gear selection by the resistance device, a request to apply a selected amount of braking force by the resistance device, or a request to apply a selected intermittent signal, embodying a simulated road surface, by the resistance device. The signal may merely be to increase resistance or reduce it, to steer, to move between selections, to move a device (e.g. a setup) up and down or elevate one end or another of a setup. The instruction may be a selected one of: an indication of a particular gear selection to which to transition the resistance device and an indication of either a desire to shift up or down one gear from one gear presently in use by the resistance device to another gear.

Thereafter, the resistance device may alter the resistance at 970 (or the speed, in the case of a treadmill). At this step, the “controller” is controlling the trainer or treadmill, but the central hub is the computing device operating the software. In this way, the software may know the current state of all of the connected devices (e.g. controllers, trainers, inclines or lean-capable accessories, treadmills, weights, etc.). And, the communications protocol may be made more secure for purposes of competitive racing and ensuring uniformity. The overall systems may also be made more uniform, reliant upon a new standardized protocol for the various pieces of information passed back and forth during a training or race session.

The process may then end at 995.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for controlling an exercise device, the system comprising:
a gear shifting device, the gear shifting device having a first communications interface for communicating with computing devices;
a computing device comprising:
a processor executing software which when executed by the processor generates a virtual world in which exercise is simulated,
a second communications interface for communicating with accessory devices, and
a third communications interface for communicating with resistance devices;
a resistance device, including a fourth communications interface for communicating with the computing device, the resistance device for applying resistance to an exercising individual operating the exercise device as directed by the software;
wherein a gear shift instruction is transmitted using the first communications interface of the gear shifting device to the second communications interface of the computing device; and
wherein a resistance instruction, based upon the gear shift instruction is transmitted by the third communications interface to the fourth communications interface of the resistance device.

2. The system of claim 1 wherein the resistance instruction sent by the third communications interface to the fourth communications interface is first translated from the gear shift instruction into a succession of resistance settings for the resistance device to simulate a selected one of: a gear shift, application of a brake, and a texture of a road or environment within the virtual world simulated by the software,
or the resistance instruction comprises the gear shift instruction.

3. The system of claim 1 wherein the resistance device is a selected one of a bicycle trainer, an indoor bicycle, a rowing machine, a resistance weight machine, and a treadmill.

4. The system of claim 1 wherein the gear shift instruction is an instruction to change a gear ratio associated with the exercise device and being simulated by the resistance device as directed by the software to simulate exercise within the virtual world.

5. The system of claim 1 wherein the gear shifting device is a selected one of: a remote control, a video game controller, an electronic or manual gear-shifting lever or group of levers, and a specially-designed controller for use with at least one of the exercise device, resistance device, and the software.

6. The system of claim 1 wherein the gear shift instruction received by the computing device is a selected one of:
an indication of a particular gear selection to which to transition the resistance device; and
an indication of either a desire to shift up or down one gear from a gear presently in use by the resistance device to another gear.

7. The system of claim 6 wherein the gear shift instruction is translated by the computing device before transmission to the resistance device into a selected one of:
a numerical resistance to be applied by the resistance device;
a percentage reduction or increase in resistance to be applied by the resistance device; and
a numerical reduction or increase in resistance to be applied by the resistance device.

1. A system for controlling an exercise device, the system comprising:
a remote control device, the remote control device having a first communications interface for communicating with computing devices;
a computing device comprising:
a processor executing software which when executed by the processor generates a virtual world in which exercise is simulated,
a second communications interface for communicating with accessory devices, including the remote control device, and
a third communications interface for communicating with resistance devices;
a resistance device, including a fourth communications interface for communicating with a computing device, the resistance device for applying resistance to an exercising individual operating the exercise device as directed by the software;
wherein a resistance altering instruction is transmitted using the first communications interface of the remote control device to the second communications interface of the computing device; and
wherein a resistance instruction, based upon the resistance altering instruction is transmitted by the third communications interface to the fourth communications interface of the resistance device.

2. The system of claim 8 wherein the resistance instruction sent by the third communications interface to the fourth communications interface is first translated from the resistance altering instruction into a succession of resistance settings for the resistance device to simulate a selected one of: a gear shift, application of a brake, and a texture of a road or environment within the virtual world simulated by the software,
or the resistance instruction comprises the resistance altering instruction.

3. The system of claim 8 wherein the resistance device is a selected one of a bicycle trainer, an indoor bicycle, a rowing machine, a resistance weight machine, and a treadmill.

4. The system of claim 8 wherein the resistant altering instruction is an instruction to change a gear ratio associated with the exercise device and being simulated by the resistance device as directed by the software to simulate exercise within the virtual world.

5. The system of claim 8 wherein the remote control device is a selected one of: a remote control, a video game controller, an electronic or manual gear-shifting lever or group of levers, and a specially-designed controller for use with at least one of the exercise device, resistance device, and the software.

6. The system of claim 8 wherein the resistance altering instruction received by the computing device is a selected one of:
an indication of a particular gear selection to which to transition the resistance device;
an indication of either a desire to shift up or down one gear from a presently-selected gear selection by the resistance device;
a request to apply a selected amount of braking force by the resistance device;
a request to apply a selected intermittent signal, embodying a simulated road surface, by the resistance device.

7. The system of claim 13 wherein the resistance altering instruction is translated by the computing device before transmission to the resistance device into a selected one of:
a numerical resistance to be applied by the resistance device;
a percentage reduction or increase in resistance to be applied by the resistance device;
a numerical reduction or increase in resistance to be applied by the resistance device;
a series of numerical resistances to be applied by the resistance device; and
a waveform or portion thereof describing a variable resistance over a period of time to be applied by the resistance device.

8. A system for control of a resistance device, the system comprising:
the resistance device in communication with a computing device executing software to simulate a virtual environment in which exercise may take place with resistance for the exercise provided by the resistance device as directed by the software;
the computing device comprising a processor and memory, the processor executing the software to generate the virtual environment in which a user may engage in the exercise;
a remote control, the remote control in communication with the computing device for providing resistance setting signals to the computing device; and
wherein the resistance setting signals are translated by the computing device into a resistance control signals by the computing device which is then transmitted to the resistance device to alter the resistance applied by the resistance device.

9. The system of claim 15 wherein the resistance control signals is an instruction causing the resistance device to simulate a selected one of: a gear shift, application of a brake, and a texture of a road or environment within the virtual world simulated by the software.

10. The system of claim 15 wherein the resistance device is a selected one of a bicycle trainer, an indoor bicycle, a rowing machine, a resistance weight machine, and a treadmill.

11. The system of claim 1 wherein the remote control is a selected one of: a handlebar mounted remote, a video game controller, an electronic or manual gear-shifting lever or group of levers, and a specially-designed controller for use with at least one of the exercise device, resistance device, and the software.

12. The system of claim 1 wherein the resistance setting signals instruction received by the computing device is a selected one of:
an indication of a particular gear selection to which to transition the resistance device;
an indication of either a desire to shift up or down one gear from a presently-selected gear selection by the resistance device;
a request to apply a selected amount of braking force by the resistance device;
a request to apply a selected intermittent signal, embodying a simulated road surface, by the resistance device.

13. The system of claim 6 wherein the resistance control signals is translated by the computing device before transmission to the resistance device into a selected one of:
a numerical resistance to be applied by the resistance device;
a percentage reduction or increase in resistance to be applied by the resistance device;
a numerical reduction or increase in resistance to be applied by the resistance device;
a series of numerical resistances to be applied by the resistance device; and
a waveform or portion thereof describing a variable resistance over a period of time to be applied by the resistance device.
